(19) United States
(12) Patent Application Publication
(10) Pub. No.: US 2025/0246745 A1
(43) Pub. Date: Jul. 31, 2025

(54) BATTERY PACK

(71) Applicant: TOYOTA JIDOSHA KABUSHIKI KAISHA, Toyota-shi (JP)

(72) Inventor: Ryo Sakurada, Nisshin-shi (JP)

(73) Assignee: TOYOTA JIDOSHA KABUSHIKI KAISHA, Toyota-shi (JP)

(21) Appl. No.: 18/977,338

(22) Filed: Dec. 11, 2024

(30) Foreign Application Priority Data
Jan. 26, 2024 (JP) 2024-010353

(51) Int. Cl. H01M 50/293; H01M 10/613; H01M 10/656; H01M 50/204; H01M 50/249; H01M 50/258; H01M 50/503; H01M 50/507

(52) U.S. Cl. CPC H01M 50/293; H01M 10/613; H01M 10/656; H01M 50/204; H01M 50/249; H01M 50/258; H01M 50/503; H01M 50/507; H01M 2220/20

(57) ABSTRACT

A battery pack includes: a case; a plurality of battery modules stacked and housed in the case; a sealing material, made of resin, provided on outside of end portions of the battery modules; current-carrying plates stacked and provided between the battery modules in a manner that end portions of the current-carrying plates are positioned inside of the end portions of the battery modules and electrically connect between the battery modules; cooling elements stacked and provided between the battery modules in a manner that end portions of the cooling elements are positioned inside of the end portions of the battery modules and cool the battery modules; and a filling material filled in the case, for fixing the battery module, the current-carrying plate, and the cooling elements among each other and inside the case.

### CROSS-REFERENCE TO RELATED APPLICATION(S)

The present application claims priority to and incorporates by reference the entire contents of Japanese Patent Application No. 2024-010353 filed in Japan on Jan. 26, 2024.

### BACKGROUND

The present disclosure relates to a battery pack.

Japanese Laid-open Patent Publication No. 2018-081820 describes the battery including the anisotropic stretching portion, located on the outer periphery of the single cell, including the seal portion for sealing the inside of the single cell, and the side regulating portion provided between the side wall portion and the anisotropic stretching portion of the cell case.

### SUMMARY

The present disclosure was made in view of the above, and an object thereof is to provide a battery pack capable of appropriately fixing the battery module in the case.

According to an embodiment, a battery pack includes: a case; a plurality of battery modules stacked and housed in the case; a sealing material, made of resin, provided on outside of end portions of the battery modules; current-carrying plates stacked and provided between the battery modules in a manner that end portions of the current-carrying plates are positioned inside of the end portions of the battery modules and electrically connect between the battery modules; cooling elements stacked and provided between the battery modules in a manner that end portions of the cooling elements are positioned inside of the end portions of the battery modules and cool the battery modules; and a filling material filled in the case, for fixing the battery module, the current-carrying plate, and the cooling elements among each other and inside the case.

### BRIEF DESCRIPTION OF THE DRAWINGS

FIG. 1 is a cross-sectional view of a battery pack according to a first embodiment;

FIG. 2 is a cross-sectional view of a battery pack according to a second embodiment;

FIG. 3 is a view of an overhang portion of FIG. 2 from above; and

FIG. 4 is a cross-sectional view of a battery pack according to a third embodiment.

### DETAILED DESCRIPTION

In the related art, when the anisotropic stretching portion and the side regulating portion are made of resin from each other, since the resins have low adhesiveness, there may be a case where the battery cell cannot be appropriately fixed in the case.

A battery pack according to an embodiment of the present disclosure will be described with reference to the drawings. In addition, components in the following embodiments include those which can be substituted and easily by those skilled in the art, or those which are substantially the same.

### First Embodiment

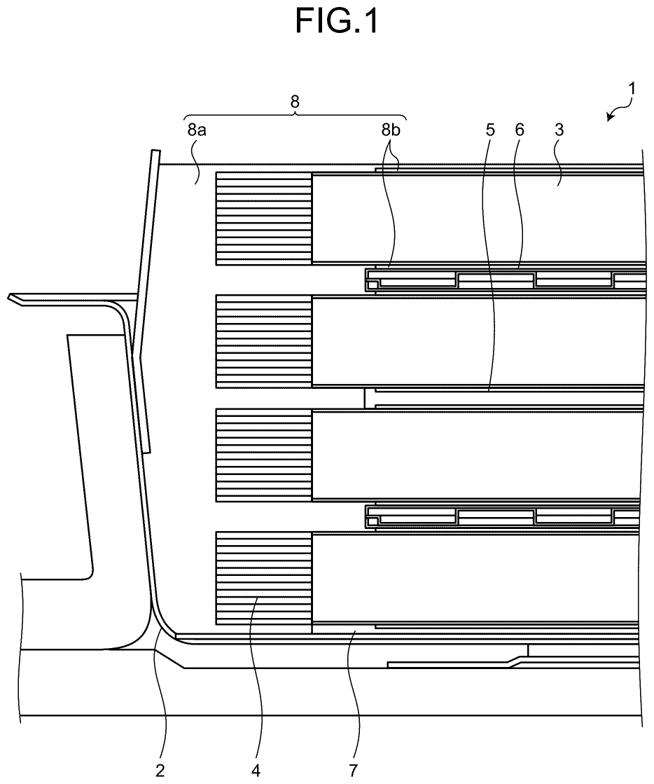

FIG. 1 is a cross-sectional view of a battery pack according to a first embodiment. The battery pack 1 includes a case 2, battery modules 3, a sealing material 4, a current conducting plate (current-carrying plate) 5, a cooler (cooling element) 6, a current collecting member 7, and a filling material 8.

The battery pack 1 is, for example, a battery mounted on the vehicle.

The case 2 accommodates each member constituting the battery pack 1.

The battery module 3 includes a plurality of layers stacked along the stacking direction (vertical direction in FIG. 1). A plurality of stacked battery modules 3 are housed in the case 2.

The sealing material 4 is provided outside the end portion of the battery module 3 (end portion in a direction perpendicular to the stacking direction, i.e. the end portion on the left side of FIG. 1). The sealing material 4 is made of a member having an insulating property such as resin, to protect the battery module 3.

The current-carrying plate 5, the end portion is stacked between the battery module 3 so as to be positioned inside the end portion of the battery module 3. The current-carrying plate 5 electrically connects between the battery module 3.

The cooler 6 is stacked between the battery module 3 so that the end portion is located inside the end of the battery module 3. The cooler 6 cools the battery module 3.

The current collecting member 7 takes out the power of the stacked battery module 3 as the total positive terminal, or total negative terminal.

The filling material 8 is filled in the case 2, to fix the battery module 3, the current-carrying plate 5 and the cooler 6 in the case 2 together with adhering to each other. The filling material 8 includes a filling portion 8a that fills the gap between the battery module 3 and the sealing material 4 and the case 2, between the battery module 3 and the current-carrying plate 5, and the battery module 3 and the cooler 6 and penetrates between the battery module 3, the current-carrying plate 5, and an adhesive portion 8b for bonding the battery module 3 and the cooler 6, respectively. The filling material 8 is made of a material such as a resin which changes into a solid state after being filled into the case 2 in a liquid state.

According to the first embodiment described above, by the end portion of the current-carrying plate 5 and the end portion of the cooler 6 to be placed inner side of the end portion of the battery module 3, good adhesive is achieved between the resin battery module 3, the current-carrying plate 5, and the cooler 6 with the filling material 8. Therefore, the battery module 3 can be appropriately fixed in the case 2.

Further, according to the first embodiment, since the filling material 8 is made of a material such as a resin that changes to a solid state after being filled into the case 2 in a liquid state, and the filling material 8 becomes a shape that follows the shape of each configuration. Therefore, the battery module 3 can be appropriately fixed in the case 2.

Further, according to the first embodiment, since it is not necessary to apply a separate adhesive between the battery module 3 and the current-carrying plate 5, and between the battery module 3 and the cooler 6, it is possible to select the material of the current-carrying plate 5 and the cooler 6 without considering the adhesive property. As a result, it is possible to select a material having a higher current-carrying performance as the current-carrying plate 5, it is possible to select a material having a higher cooling performance as the cooler 6.

### Second Embodiment

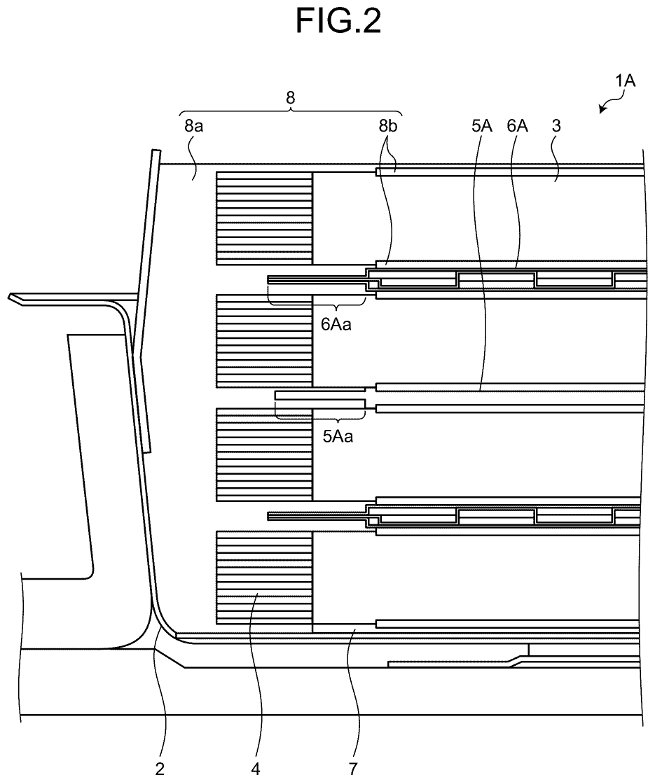

FIG. 2 is a cross-sectional view of a battery pack according to a second embodiment. As illustrated in FIG. 2, in the battery-pack 1A, the current-carrying plate 5A is 5Aa provided with an overhang portion extending from the end of the battery module 3 to the outer side. Likewise, the cooler 6A is provided with an overhang 6Aa extending outward from the end of the cell module 3.

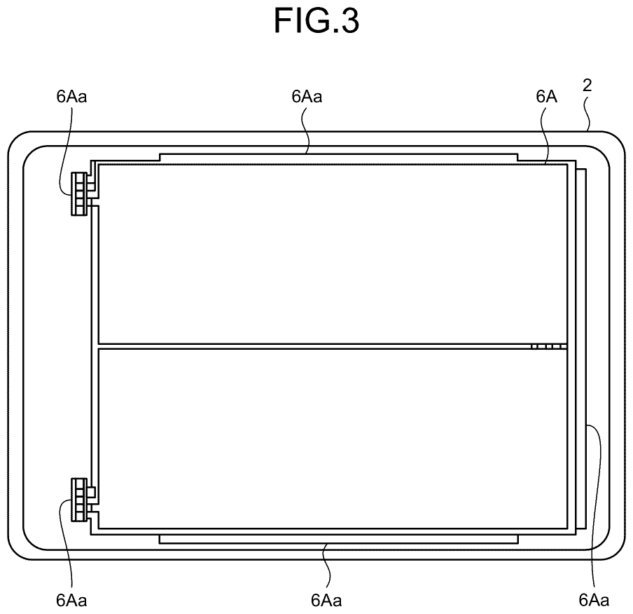

FIG. 3 is a view of the overhang portion of FIG. 2 from above. As illustrated in FIG. 3, the overhang portion 6Aa of the cooler 6A is provided at least one location or more on each side. Similarly, the overhang 5Aa portion of the current-carrying plate 5A may be configured to be provided at least one location or more on each side.

According to the second embodiment described above, by providing the overhang portion 5Aa and overhang portion 6Aa, since the adhesive area is increased, it is possible to firmly fix the battery module 3 in the case 2.

Incidentally, the overhang portion 5Aa and overhang portion 6Aa, by being provided at least one location on each side, the current-carrying plate 5A and the cooler 6A and the filling material 8 at each side is more firmly bonded.

### Third Embodiment

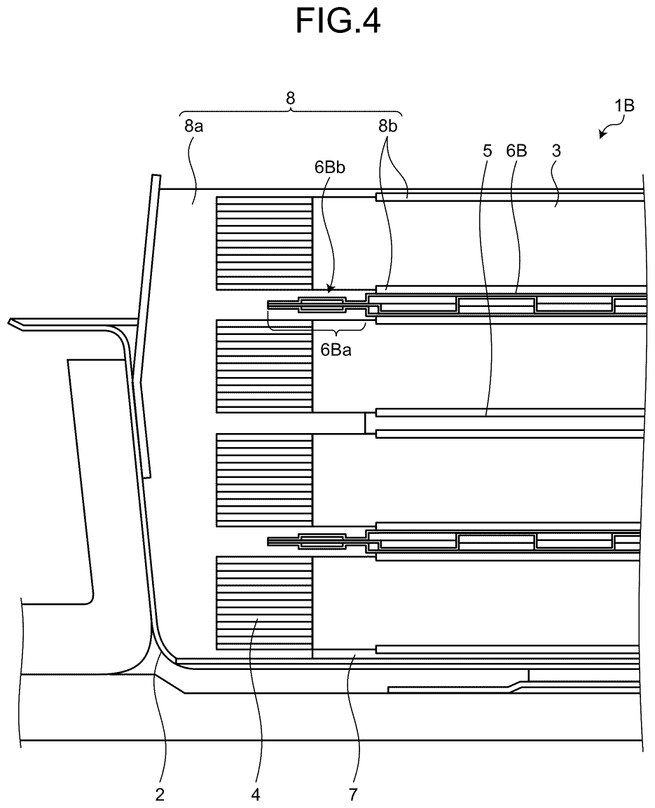

FIG. 4 is a cross-sectional view of a battery pack according to a third embodiment. As illustrated in FIG. 4, in the battery pack 1B, the overhang 6Ba extending from the cooler 6B has a cooling flow passage 6Bb formed therein.

According to the third embodiment described above, since the cooling flow passage 6Bb is formed inside the overhanging portion 6Ba, the cooling performance can be improved.

According to the present disclosure, it is possible to realize a battery pack in which the battery module can be appropriately fixed in the case.

Further effects and variations can be readily derived by one skilled in the art. Thus, the broader aspects of the invention are not limited to the particular details and representative embodiments described and represented above. Accordingly, various modifications are possible without departing from the spirit or scope of the overall inventive concept defined by the appended claims and their equivalents.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A battery pack comprising:
a case;
a plurality of battery modules stacked and housed in the case;
a sealing material, made of resin, provided on outside of end portions of the battery modules;
current-carrying plates stacked and provided between the battery modules in a manner that end portions of the current-carrying plates are positioned inside of the end portions of the battery modules and electrically connect between the battery modules;
cooling elements stacked and provided between the battery modules in a manner that end portions of the cooling elements are positioned inside of the end portions of the battery modules and cool the battery modules; and
a filling material filled in the case, for fixing the battery module, the current-carrying plate, and the cooling elements among each other and inside the case.

2. The battery pack according to claim 1, wherein
the current-carrying plates or the cooling elements include overhang portions extending from the end portions of the battery modules to the outside.

3. The battery pack according to claim 2, wherein
the overhang portions extending from the cooling elements have cooling flow passages formed therein.

4. The battery pack according to claim 1, wherein
the filling material is made of a material which changes into a solid state after being filled into the case in a liquid state.
